(19) United States
(12) Patent Application Publication
(10) Pub. No.: US 2010/0324242 A1
(43) Pub. Date: Dec. 23, 2010

(54) HIGHLY PURE, TERMINAL-UNSATURATED OLEFIN POLYMER AND PROCESS FOR PRODUCTION THEREOF

(75) Inventors: Shuji Machida, Chiba (JP); Ryo Aburatani, Chiba (JP); Takenori Fujimura, Chiba (JP); Takehiro Tsuda, Chiba (JP); Yutaka Minami, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Idemitsu Kosan Co., Ltd., Chiyoda-ku,Tokyo (JP)

(21) Appl. No.: 12/446,397

(22) PCT Filed: Oct. 18, 2007
(86) PCT No.: PCT/JP2007/070336

§ 371 Date: Apr. 20, 2009

(30) Foreign Application Priority Data
Oct. 20, 2006 (JP) 2006-285739

(51) Int. Cl. C08F 210/06; C08F 210/08; C08F 210/00; C08F 4/52

(52) U.S. Cl. 526/160; 526/348.6; 526/348.2; 526/348.3; 526/348.4; 526/351

(57) ABSTRACT

Provided are a highly-pure, terminal-unsaturated olefin polymer which is produced through homopolymerization or copolymerization of one or more α-olefins having from 3 to 28 carbon atoms, or copolymerization of at least one α-olefin having from 3 to 28 carbon atoms and ethylene, in the presence of a catalyst, and which satisfies the following (1) to (4); and a method of efficiently producing the olefin polymer having a high degree of terminal unsaturation degree and containing little catalyst residue.
(1) The content of the transition metal derived from the catalyst is at most 10 ppm by mass, the content of aluminium is at most 300 ppm by mass, and the content of boron is at most 10 ppm by mass;
(2) The polymer has from 0.5 to 1.0 vinylidene group/molecule as the terminal unsaturated group;
(3) The polymer has an intrinsic viscosity [η], as measured in decalin at 135° C., of from 0.01 to 2.5 dl/g;
(4) The polymer has a molecular weight distribution (Mw/Mn) of at most 4.

### TECHNICAL FIELD

The present invention relates to a highly-pure, terminal-unsaturated olefin polymer and a method for producing it, and precisely, relates to a highly-pure, terminal-unsaturated olefin polymer which, as having a terminal unsaturated group and capable of readily receiving a polar functional group introduced thereinto, has a function as a macromonomer and has a broad latitude in structure control for random structures and block structures and which is favorable as a reactive precursor for efficiently producing a modified polymer, and also to a production method for producing the olefin polymer at high activity.

### BACKGROUND ART

Heretofore, polyolefins such as polyethylene, polypropylene and the like are widely used in the filed of automobiles, household electric appliances, miscellaneous goods, electric and electronic instruments and others, as having high chemical stability and further having excellent mechanical properties. Introducing a polar group of an unsaturated carboxylic acid or the like thereinto through polymer reaction to thereby enhance the adhesiveness and the compatibility with heterogeneous materials of the polymers is generally effected; however, owing to the obstacle of high chemical stability, there is a limit to the technique of impartation of a desired function to the polymers. It is expected to further enhance the reactivity of polyolefins within a range not detracting from the chemical stability thereof and with maintaining the advantages of polyolefins, to thereby enlarge the applicability of polyolefins to composite materials with heterogeneous materials, to resin modifiers, etc.

As low-tacticity polypropylenes, disclosed are polypropylenes characterized by multi-block structure, tacticity distribution and tacticity and others (for example, see Patent References 1 to 6). These low-tacticity polypropylenes are problematic in that the activity of the catalyst to be used in polymerization is low and the amount of the catalyst residue is large, and therefore the polymers contain much impurity. In addition, Patent References 1 to 6 have no description relating to terminal structures. Patent Reference 7 discloses high-tacticity polypropylenes having a high triad fraction [mm] and atactic propylene copolymers. Patent Reference 7 says that the polypropylenes disclosed therein have a high degree of terminal unsaturation, but they contain much catalyst residue.

Patent References 8 to 10 disclose a technique relating to a double-crosslinked catalyst/MAO (methylaluminoxane) catalyst system. Example 3 in Patent Reference 9 is to demonstrate an example of polymerization of propylene using MAO and also using hydrogen as a molecular weight-controlling agent, which, however, is silent on the terminal structure of the polymer. As a result of trying the process of this Example, the terminal unsaturated group was about 0.05 per one molecule, and most terminals were saturated through chain transfer to hydrogen. Example 5 in Reference 10 is to demonstrate an example of polymerization of propylene using MAO but not using hydrogen as a molecular weight-controlling agent. As a result of trying the process of this Example, the molecular weight of propylene increased and the terminal concentration decreased greatly, and therefore it was impossible to analyze the terminal structure. In addition, since the catalyst activity was low and the quantity of the catalyst residue was large, there occurred a problem in that the polymer contained much impurity.

[Patent Reference 1] JP-T 9-509982

[Patent Reference 2] JP-T 9-510745

[Patent Reference 3] JP-A 2005-226078

[Patent Reference 4] JP-T 2004-515581

[Patent Reference 5] JP-T 2002-511499

[Patent Reference 6] JP-T 2002-511503

[Patent Reference 7] JP-A 4-226506

[Patent Reference 8] WO96/30380

[Patent Reference 9] WO02/24714

[Patent Reference 10] JP-A 2000-256411

### DISCLOSURE OF THE INVENTION

### Problems that the Invention is to Solve

The present invention has been made in consideration of the above-mentioned situation, and its object is to provide a high-purity olefin polymer which contains little catalyst residue and has a high terminal unsaturation degree which is favorable as a reactive precursor, and to provide a method of efficiently producing it.

### Means for Solving the Problems

The present inventors have assiduously studied and, as a result, have found that the object can be attained by a highly-pure, terminal-unsaturated olefin polymer which is produced through homopolymerization or copolymerization of one or more specific α-olefins, or copolymerization of at least one specific α-olefin and ethylene, and which satisfies specific requirements. The present invention has been completed on the basis of these findings.

Specifically, the present invention provides a highly-pure, terminal-unsaturated olefin polymer and its production method mentioned below.

1. A highly-pure, terminal-unsaturated olefin polymer which is produced through homopolymerization or copolymerization of one or more α-olefins having from 3 to 28 carbon atoms, or copolymerization of at least one α-olefin having from 3 to 28 carbon atoms and ethylene, and which satisfies the following (1) to (4):

(1) The content of the transition metal derived from the catalyst is at most 10 ppm by mass, the content of aluminium is at most 300 ppm by mass, and the content of boron is at most 10 ppm by mass;
(2) The polymer has from 0.5 to 1.0 vinylidene group/molecule as the terminal unsaturated group;
(3) The polymer has an intrinsic viscosity [η], as measured in decalin at 135° C., of from 0.01 to 2.5 dl/g;
(4) The polymer has a molecular weight distribution (Mw/Mn) of at most 4.

2. The highly-pure, terminal-unsaturated olefin polymer of above 1, which has from 0.8 to 1.0 vinylidene group/molecule as the terminal unsaturated group.

3. The highly-pure, terminal-unsaturated olefin polymer of above 1, wherein the olefin polymer is a propylene homopolymer, or a copolymer of at least 90% by mass of propylene and at most 10% by mass of at least one selected from ethylene and α-olefins having from 4 to 28 carbon atoms, and has a mesopentad fraction [mmmm] of from 30 to 80 mol %.

4. The highly-pure, terminal-unsaturated olefin polymer of above 3, which satisfies the following (a) and (b):

(a) [rmrm]>2.5 mol %,
(b) The melting point (Tm, unit ° C.) of the polymer, as measured with a differential scanning calorimeter (DSC), and [mmmm] thereof satisfy the following requirement:

1.76[mmmm]−25.0≦Tm≦1.76[mmmm]+5.0.

5. The highly-pure, terminal-unsaturated olefin polymer of above 1, wherein the olefin polymer is a 1-butene homopolymer, or a copolymer of at least 90% by mass of 1-butene and at most 10% by mass of at least one selected from ethylene, propylene and α-olefins having from 5 to 28 carbon atoms, and has a mesopentad fraction [mmmm] of from 20 to 90 mol %.

6. The highly-pure, terminal-unsaturated olefin polymer of above 5, which satisfies the following (p) and (q):

(p) The polymer is a resin not having a melting point (Tm) in differential scanning calorimetry (DSC) or a crystalline resin having a melting point (Tm) of from 0 to 100° C.
(q) {[mmmm]/[mmrr]+[rmmr]}≦20.

7. A method for producing a highly-pure, terminal-unsaturated olefin polymer of the above 1, which comprises homopolymerization or copolymerization of one or more α-olefins having from 3 to 28 carbon atoms, or copolymerization of at least one α-olefin having from 3 to 28 carbon atoms with ethylene, in the presence of a catalyst comprising the following (A) and (B), or the following (A), (B) and (C), and in which the polymerization reaction is attained in a molar ratio of hydrogen to the transition metal compound (hydrogen/transition metal compound) of from 0 to 5000:

(A) A transition metal compound having a cyclopentadienyl group, a substituted cyclopentadienyl group, an indenyl group or a substituted indenyl group and containing a metal element of Groups 3 to 10 of the Periodic Table;
(B) A compound capable of reacting with the transition metal compound to form an ionic complex;
(C) An organoaluminium compound.

8. The method for producing a highly-pure, terminal-unsaturated olefin polymer of above 7, wherein the polymerization reaction is attained in a molar ratio of hydrogen to the transition metal compound (hydrogen/transition metal compound) of from 0 to 10000.

9. The method for producing a highly-pure, terminal-unsaturated olefin polymer of above 7, wherein the transition metal compound is a double-crosslinked complex of a general formula (I):

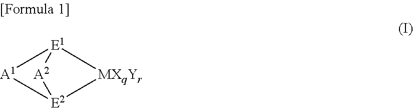

[wherein M represents a metal element of Groups 3 to 10 of the Periodic Table; E¹ and E² each represent a ligand selected from a cyclopentadienyl group, a substituted cyclopentadienyl group, an indenyl group, a substituted indenyl group, a heterocyclopentadienyl group, a substituted heterocyclopentadienyl group, an amide group, a phosphine group, a hydrocarbon group and a silicon-containing group, and form a crosslinking structure via A¹ and A²; E¹ and E² may be the same or different, and at least one of E¹ and E² is a cyclopentadienyl group, a substituted cyclopentadienyl group, an indenyl group or a substituted indenyl group; X represents a σ-bonding ligand; plural X's, if any, may be the same or different, and may crosslink with the other X, E¹, E² or Y; Y represents a Lewis base; plural Y's, if any, may be the same or different, and may crosslink with the other Y, E¹, E² or X; A¹ and A² each are a divalent crosslinking group that bonds two ligands, representing a hydrocarbon group having from 1 to 20 carbon atoms, a halogen-containing hydrocarbon group having from 1 to 20 carbon atoms, a silicon-containing group, a germanium-containing group, a tin-containing group, —O—, —CO—, —S—, —SO₂—, —Se—, —NR¹—, —PR¹—, —P(O)R¹—, —BR¹— or —AlR¹— where R¹ represents a hydrogen atom, a halogen atom, a hydrocarbon group having from 1 to 20 carbon atoms, or a halogen-containing hydrocarbon group having from 1 to 20 carbon atoms, and they may be the same or different; q indicates an integer of from 1 to 5, and is [(atomic valence of M)−2]; r indicates an integer of from 0 to 3].

### EFFECT OF THE INVENTION

According to the present invention, there is provided a highly-pure, terminal-unsaturated olefin polymer having a vinylidene structure at the terminal and most suitable for polymer reaction. The highly-pure, terminal-unsaturated olefin polymer of the present invention contains little catalyst residue and is applicable to various reactions as a highly-pure reactive precursor.

### BEST MODE FOR CARRYING OUT THE INVENTION

The highly-pure, terminal-unsaturated olefin polymer of the present invention is produced through homopolymerization or copolymerization of one or more α-olefins having from 3 to 28 carbon atoms, or copolymerization of at least one α-olefin having from 3 to 28 carbon atoms with ethylene.

The α-olefin having from 3 to 28 carbon atoms includes propylene, 1-butene, 1-pentene, 4-methylpentene-1, 1-hexene, 1-octene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, etc. One or more of these may be used either singly or as combined.

In α-olefin homopolymerization, preferred is an α-olefin having from 3 to 8 carbon atoms, and more preferred is propylene or 1-butene. In copolymerization of two or more α-olefins having from 3 to 28 carbon atoms or in copolymerization of at least one α-olefin having from 3 to 28 carbon atoms with ethylene, the monomer combination includes propylene and ethylene; propylene and 1-butene; propylene and at least one α-olefin having from 5 to 28 carbon atoms; 1-butene and ethylene; 1-butene and at least one α-olefin having from 5 to 28 carbon atoms; from 2 to 6 α-olefins having from 16 to 28 carbon atoms; etc.

In case where the highly-pure, terminal-unsaturated olefin polymer of the present invention is a propylene-based polymer or a 1-butene-based polymer, the comonomer content therein is preferably at most 10% by mass from the viewpoint of keeping a high concentration of the terminal vinylidene group.

The highly-pure, terminal-unsaturated olefin polymer of the present invention is produced through polymerization of the above-mentioned α-olefin in the presence of a catalyst, and must satisfy the following (1) to (4).

(1) The content of the transition metal derived from the catalyst is at most 10 ppm by mass, the content of aluminium is at most 300 ppm by mass, and the content of boron is at most 10 ppm by mass.

This is to define the amount of the metal components based on the catalyst residue. The transition metal includes titanium, zirconium, hafnium, etc. Their total amount must be at most 10 ppm by mass. Preferably, it is at most 5 ppm by mass. The aluminium content is preferably at most 280 ppm by mass, the boron content is preferably at most 5 ppm by mass. These metal components may be measured with ICP (high-frequency induction-coupled plasma spectrometer).

(2) The polymer has from 0.5 to 1.0 terminal vinylidene group/molecule as the terminal unsaturated group.

The number of the terminal vinylidene group may be determined through ¹H-NMR according to an ordinary method. Based on the terminal vinylidene group appearing at δ4.8 to 4.6 (2H) in ¹H-NMR, the content (C) (mol %) of the terminal vinylidene group is computed according to an ordinary method. Further, from the number-average molecular weight (Mn) obtained through gel permeation chromatography (GPC) and the molecular weight (M) of the monomer, the number of the terminal vinylidene group/molecule is computed according to the following formula:

Number of terminal vinylidene group/molecule=(Mn/M)×(C/100).

Apart from the above-mentioned method, the number of the terminal vinylidene group may be determined through ¹³C-NMR. In this method, the type of all the terminal groups is determined, and their amount is measured. From the ratio of the amount of the terminal vinylidene group to that of all the terminal groups, the number of the terminal vinylidene group/molecule may be determined; and from the ratio of the amount of the terminal vinylidene group to that of all the unsaturated groups, the selectivity of the terminal vinylidene group may be determined. This is described with reference to a propylene polymer as an example.

### (Analysis of Unsaturated Terminal Groups Through ¹H-NMR)

The propylene polymer of the present invention shows <2> methylene group of terminal vinylidene group (4.8 to 4.6 ppm), and <1> methylene group of terminal vinyl group (5.10 to 4.90 ppm). The proportion to all propylene is computed according to the formula mentioned below. <3> corresponds to the peak intensity for methine, methylene and methyl groups of the propylene chain (0.6 to 2.3 ppm).

Amount of terminal vinylidene group (A)=(<2>/2)/[(<3>+4×<1>/2+3×<2>/2)/6]×100 (unit, mol %)

Amount of terminal vinyl group (B)=(<1>/2)/[(<3>+4×<1>/2+3×<2>/2)/6]×100 (unit, mol %)

### (Analysis of Terminal Fraction Through ¹³C-NMR)

The propylene polymer of the present invention shows <5> terminal methyl group of n-propyl terminal (around 14.5 ppm), <6> terminal methyl group of n-butyl group terminal (around 14.0 ppm), <4> methine group of iso-butyl terminal (around 25.9 ppm), <7> methylene group of terminal vinylidene group (around 111.7 ppm). The peak intensity of the terminal vinyl group in ¹³C-NMR is computed as follows, using (A) and (B) obtained in ¹H-NMR spectrometry.

Peak intensity of terminal vinyl group in ¹³C-NMR=(B)/(A)×<7>

In this, the total concentration (T) of the terminal groups is represented as follows:

T=(B)/(A)×<7>+<4>+<5>+<6>+<7>

Accordingly, the proportion of each terminal is as follows:

(C) terminal vinylidene group=<7>/T×100 (unit, mol %)

(D) terminal vinyl group=(B)/(A)×<7>×100

(E) n-propyl terminal=<5>/T×100

(F) n-butyl terminal=<6>/T×100

(G) iso-butyl terminal=<4>/T×100

The number of the terminal vinylidene group/molecule is: 2×(C)/100 (unit, per molecule)

In the highly-pure, terminal-unsaturated olefin polymer of the present invention, the number of the terminal vinylidene group per molecule is preferably from 0.6 to 1.0, more preferably from 0.7 to 1.0, even more preferably from 0.8 to 1.0, still more preferably from 0.82 to 1.0, further more preferably from 0.85 to 1.0, most preferably from 0.90 to 1.0. When the number of the terminal vinylidene group per molecule is at least 0.5, then the reactive precursor can exhibit its function.

(3) The polymer has an intrinsic viscosity [η], as measured in decalin at 135° C., of from 0.01 to 2.5 dl/g.

Using an Ubbelohde viscometer, the reduced viscosity (η_{SP}/c) of the polymer is measured in decalin at 135° C., and the intrinsic viscosity [η] thereof is computed according to the following formula (Huggins formula):

η_{SP}/c=[η]+K[η]²c,

η_{SP}/c (dl/g): reduced viscosity,
[η] (dl/g): intrinsic viscosity,
c (g/dl): polymer concentration,
K=0.35 (Huggins constant).

Of the highly-pure, terminal-unsaturated olefin polymer of the present invention, the intrinsic viscosity [η] is preferably from 0.05 to 2.3 dl/g, more preferably from 0.07 to 2.2 dl/g, even more preferably from 0.1 to 2.0 dl/g. When the intrinsic viscosity [η] of the olefin polymer is at least 0.01 dl/g, then the molecular weight thereof is not too low, and therefore the polymer may keep its chemical stability; and when at most 2.5 dl/g, then the concentration of the terminal unsaturated group in the polymer is prevented from lowering, and therefore the polymer may keep the characteristics thereof as a reactive precursor.

(4) The polymer has a molecular weight distribution (Mw/Mn) of at most 4.

When the molecular weight distribution (Mw/Mn) of the highly-pure, terminal-unsaturated olefin polymer of the present invention is at most 4, then the molecular chain length can be uniform, and therefore the uniformity of the polymer as a reactive precursor is high, and the amount of the sticky component is reduced in the region of the polymer having a large intrinsic viscosity.

The molecular weight distribution (Mw/Mn) can be determined by measuring the weight-average molecular weight (Mw) and the number-average molecular weight (Mn) of the polymer through gel permeation chromatography (GPC), using the following apparatus under the following condition.

### GPC Apparatus:

Detector: RI detector for liquid chromatography, Waters 150 C

### Column: TOSO GMHHR-H(S)HT

### Condition:

Solvent: 1,2,4-trichlorobenzene

### Temperature: 145° C.

Flow rate: 1.0 ml/min
Sample concentration: 0.3% by mass

The weight-average molecular weight (Mw) and the number-average molecular weight (Mn) are converted into the molecular weight of the polymer corresponding to the polystyrene-based molecular weight thereof, and therefore, these are determined according to a Universal Calibration method using Mark-Houwink-Sakurada's constants K and a. Concretely, these are determined according to the method described in “Size Exclusion Chromatography”, by Sadao Mori, pp. 67-69, 1992, by Kyoritsu Publishing. K and α are described in “Polymer Handbook”, John Wiley & Sons, Inc. Alternatively, these may also be determined according to an ordinary method from the relation of the intrinsic viscosity to the absolute molecular weight to be additionally computed.

Of the highly-pure, terminal-unsaturated olefin polymer of the present invention, the propylene homopolymer or the copolymer of at least 90% by mass or propylene and at most 10% by mass of at least one selected from ethylene and α-olefins having from 4 to 28 carbon atoms (hereinafter these may be referred to as “propylene-based polymer”) are preferably such that the mesopentad fraction [mmmm] to be the tacticity thereof falls within a range of from 30 to 80 mol %, in addition to the above-mentioned (1) to (4).

The mesopentad fraction [mmmm] is more preferably from 30 to 75 mol %, even more preferably from 32 to 70 mol %. When the mesopentad fraction is at least 30 mol %, then the propylene-based polymer can be crystalline and is resistant to heat. When at most 80 mol %, the propylene-based polymer is suitably soft, and its solubility in solvent may be good and the polymer is widely applicable to solution reaction, etc.

The above-mentioned mesopentad fraction [mmmm], and the racemipentad fraction [rrrr] and the racemi-meso-racemi-meso fraction [rmrm] to be mentioned below are the meso fraction, the racemi fraction and the racemi-meso-racemi-meso fraction as the pentad unit in the polypropylene molecular chain, as measured from the signal of the methyl group in the ¹³C-NMR spectrum of the polymer, according to the method proposed by A. Zambelli et al., in Macromolecules, 6, 925 (1973). The polymer having a larger mesopentad fraction [mmmm] has a higher tacticity.

¹³C-NMR spectrometry may be carried out, using the following apparatus under the following condition, according to the peak assignment as proposed by A. Zambelli et al., in Macromolecules, 8, 687 (1975). The mesotriad fraction [mm], the racemitriad fraction [rr] and the meso-racemi fraction [mr] to be mentioned below are also computed according to the above-mentioned method.

Apparatus: JEOL's JNM-EX400 Model ¹³C-NMR apparatus
Method: Proton complete decoupling method
Concentration: 220 mg/ml
Solvent: 1,2,4-trichlorobenzene/heavy benzene, 90/10 (by volume) mixed solvent

### Temperature: 130° C.

Pulse width: 45°
Pulse repetition interval: 4 sec
Multiplication: 10000 times

### <Computation Formula>

M=(m/S)×100

R=(γ/S)×100

S=Pββ+Pαβ+Pαγ

S: signal intensity of side-chain methyl carbon atom in total propylene unit

### Pββ: 19.8 to 22.5 ppm

### Pαβ: 18.0 to 17.5 ppm

### Pαγ: 17.5 to 17.1 ppm

γ: racemipentad chain: 20.7 to 20.3 ppm
m: mesopentad chain: 21.7 to 22.5 ppm

The above-mentioned propylene-based polymer further preferably satisfies the following (a) and (b), more preferably additionally satisfying the following (c), (d) and (e):

(a) [rmrm]>2.5 mol %.

When [rmrm] of the propylene-based polymer is more than 2.5 mol %, then the random quality thereof increases and the transparency thereof further increases.

(b) The melting point (Tm, unit ° C.) as measured with a differential scanning calorimeter (DSC) and [mmmm] of the polymer satisfy the following relationship:

1.76[mmmm]−25.0≦Tm≦1.76[mmmm]+5.0.

[mmmm] is measured as a mean value, and this could not be clearly differentiated between a case of broad tacticity distribution and a case of narrow tacticity distribution; however, by defining the relationship between [mmmm] and the melting point (Tm) of the polymer, the polymer can be a preferred reactive polypropylene of good uniformity.

The above-mentioned relational formula is more preferably as follows:

1.76[mmmm]−20.0≦Tm≦1.76[mmmm]+3.0,

even more preferably,

1.76[mmmm]−15.0≦Tm≦1.76[mmmm]+2.0.

When the melting point (Tm) is higher than (1.76[mmmm]+5.0), this means that the polymer partly has a region having a high tacticity and a region not having a tacticity. When the melting point (Tm) does not reach (1.76[mmmm]−25.0), then the heat resistance of the polymer may be insufficient.

(c) [rrrr]/(1−[mmmm])≦0.1.

When [rrrr]/(1−[mmmm]) of the above propylene-based polymer is less than 0.1, then the polymer is not sticky.

The melting point (Tm) is determined through DSC. Specifically, using a differential scanning calorimeter (Perkin Elmer's DSC-7), 10 mg of a sample is heated from 25° C. up to 220° C. in a nitrogen atmosphere at 320° C./min, then kept at 220° C. for 5 minutes, cooled to 25° C. at 320° C./min, and kept at 25° C. for 50 minutes. Then, this is heated from 25° C. up to 220° C. at 10° C./min. The peak top of the endothermic peak observed on the highest temperature side in the dissolution/heat absorption curve detected in this heating process is the melting point (Tm) of the tested sample.

(d) [mm]×[rr]/[mr]²≦2.0

When the value of [mm]×[rr]/[mr]² of the above propylene-based polymer is at most 2.0, then the transparency thereof is prevented from lowering, and the balance between the flexibility and the elasticity recovery of the polymer is good. [mm]×[rr]/[mr]² is preferably from 1.8 to 0.5, more preferably from 1.5 to 0.5.

(e) The amount of the component (W25) eluting at 25° C. or lower in temperature-programmed chromatography is from 20 to 100% by mass.

In the propylene-based polymer, the amount of the propylene-based polymer component (W25) eluting at 25° C. or lower in temperature-rising chromatography is preferably from 30 to 100% by mass, more preferably from 50 to 100% by mass.

W25 is an index of indicating whether or not the propylene-based polymer is soft; and when the value is smaller, the component having a high modulus of elasticity increases in the polymer, and the unevenness of the tacticity distribution in the polymer increases. When the propylene-based polymer has the value W25 of at least 20% by mass, then it may keep flexibility.

W25 is the amount of the component (% by mass) that is not adsorbed by the filler but is eluted at a column temperature of 25° C. in TREF (temperature-rising elution fractionation), on the elution curve drawn in temperature-rising chromatography according to the following process with the following apparatus under the following condition.

### (1) Process:

A sample solution is introduced into a TREF column conditioned at a temperature of 135° C., then gradually cooled to 0° C. at a cooling speed of 5° C./hr, and held as such for 30 minutes so that the sample is crystallized on the filler surface. Next, the column is heated up to 135° C. at a heating speed of 40° C./hr to draw an elution curve.

### (2) Apparatus Constitution:

TREF column: GL Science's silica gel column (4.6φ×150 mm)
Flow cell: GL Science's light pass length 1 mm KBr cell
Liquid feed pump: Senshu Science's SSC-3100 pump
Bulb oven: GL Science's Model 554 oven (high-temperature oven)
TREF oven: by GL Science
Two-series temperature controller: Rigaku Kogyo's REX-C100 temperature controller
Detector: IR detector for liquid chromatography, Foxboro's MIRAN 1A CVF
10-way valve: Barco's electromotive valve
Loop: Barco's 500 μl loop

### (3) Test Condition:

Solvent: o-dichlorobenzene
Sample concentration: 7.5 g/L
Sample amount; 500 μl
Pump flow rate: 2.0 ml/min
Detection wave number: 3.41 μm
Column filler: Chromosorb P (30 to 60 mesh)
Column temperature distribution: within ±0.2° C.

Of the highly-pure, terminal-unsaturated olefin polymer of the present invention, the 1-butene homopolymer or the copolymer of at least 90% by mass of 1-butene and 10% by mass of at least one selected from ethylene, propylene and α-olefins having from 5 to 28 carbon atoms (hereinafter these may be referred to as “1-butene-based polymer”) are preferably such that the mesopentad fraction [mmmm] to be the tacticity thereof falls within a range of from 20 to 90 mol %, in addition to the above-mentioned (1) to (4).

The mesopentad fraction [mmmm] is more preferably from 30 to 85 mol %, even more preferably from 30 to 80 mol %. When the mesopentad fraction is at least 20 mol %, then the surface of a shaped article produced by shaping the 1-butene-based polymer is not sticky, and the transparency thereof may be good. When at most 90 mol %, the flexibility of the polymer may be prevented from lowering, the low-temperature heat sealability thereof may be prevented from lowering, and the hot tacking property thereof may be prevented from lowering.

The mesopentad fraction [mmmm] of the above-mentioned 1-butene-based polymer is determined according to the method proposed by Asakura et al. in Polymer Journal, 16, 717 (1984); by J. Randall et al. in Macromol. Chem. Phys., C29, 201 (1989); and by V. Busico et al. in Macromol. Chem. Phys., 198, 1257 (1997). Specifically, the signals of methylene group and methine group are determined in ¹³C nuclear magnetic resonance spectrometry, and the mesopentad fraction in the poly(1-butene) molecule is determined. The tacticity index {[mmmm]/[mmrr]+[rmmr]} to be mentioned below is computed from the data of the mesopentad fraction [mmmm], the meso-meso-racemi-racemi fraction [mmrr] and the racemi-meso-meso-racemi fraction [rmmr] as measured according to the above-mentioned method.

¹³C nuclear magnetic resonance spectrometry is carried out, using the following apparatus under the following condition.

Apparatus: JEOL's JNM-EX400 Model ¹³C-NMR apparatus
Method: Proton complete decoupling method
Concentration: 230 mg/ml
Solvent: 1,2,4-trichlorobenzene/heavy benzene, 90/10 (by volume) mixed solvent

### Temperature: 130° C.

Pulse width: 45°
Pulse repetition interval: 4 sec
Multiplication: 10000 times

The above-mentioned 1-butene-based polymer further preferably satisfies the following (p) and (q):

(p) The polymer is a resin not having a melting point (Tm) in differential scanning calorimetry (DSC) or a crystalline resin having a melting point (Tm) of from 0 to 100° C. In case where the 1-butene-based polymer of the present invention has a melting point (Tm), the melting point is preferably from 0 to 80° C. The melting point is measured according to the method mentioned in the above.
(q) {[mmmm]/[mmrr]+[rmmr]}≦20.

When the tacticity index of the 1-butene-based polymer, {[mmmm]/[mmrr]+[rmmr]} is at most 20, then the flexibility of the polymer may be prevented from lowering, the low-temperature heat sealability thereof may be prevented from lowering, and the hot tacking property thereof may be prevented from lowering. The tacticity index is preferably at most 18, more preferably at most 15.

The highly-pure, terminal-unsaturated polyolefin polymer of the present invention can be produced through polymerization in the presence of a catalyst comprising the following (A) and (B) or the following (A), (B) and (C) in a molar ratio of hydrogen to the transition metal compound (hydrogen/transition metal compound) of from 0 to 10000, more preferably from 0 to 5000. The ingredient (A) is a transition metal compound having a cyclopentadienyl group, a substituted cyclopentadienyl group, an indenyl group or a substituted indenyl group and containing a metal element of Groups 3 to 10 of the Periodic Table; the ingredient (B) is a compound capable of reacting with the transition metal compound to form an ionic complex; and the ingredient (C) is an organoaluminium compound.

As the transition metal compound for the ingredient (A) having a cyclopentadienyl group, a substituted cyclopentadienyl group, an indenyl group or a substituted indenyl group and containing a metal element of Groups 3 to of the Periodic Table, there is mentioned a double-crosslinked complex of the following general formula (I):

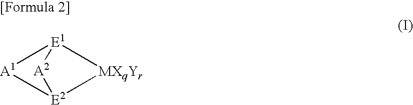

In the above general formula (I), M represents a metal element of Groups 3 to 10 of the Periodic Table. Its examples include titanium, zirconium, hafnium, yttrium, vanadium, chromium, manganese, nickel, cobalt, palladium, lanthanoid metals, etc. Of those, preferred are titanium, zirconium and hafnium from the viewpoint of the olefin polymerization activity; and most preferred is zirconium from the viewpoint of the terminal vinylidene group yield and the catalyst activity.

E¹ and E² each represent a ligand selected from a substituted cyclopentadienyl group, an indenyl group, a substituted indenyl group, a heterocyclopentadienyl group, a substituted heterocyclopentadienyl group, an amide group (—N<), a phosphine group (—P<), a hydrocarbon group [>CR—, >C<] and a silicon-containing group [>SiR—, >Si<] (in which R represents a hydrogen atom, a hydrocarbon group having from 1 to 20 carbon atoms, or a hetero atom-containing group); and they form a crosslinking structure via A¹ and A². E¹ and E² may be the same or different. For E¹ and E², preferred are a cyclopentadienyl group, a substituted cyclopentadienyl group, an indenyl group and a substituted indenyl group; and at least one of E¹ and E² is a cyclopentadienyl group, a substituted cyclopentadienyl group, an indenyl group or a substituted indenyl group.

X represents a σ-bonding ligand; plural X's, if any, may be the same or different, and may crosslink with the other X, E¹, E² or Y. Examples of X include a halogen atom, a hydrocarbon group having from 1 to 20 carbon atoms, an alkoxy group having from 1 to 20 carbon atoms, an aryloxy group having from 6 to 20 carbon atoms, an amide group having from 1 to 20 carbon atoms, a silicon-containing group having from 1 to 20 carbon atoms, a phosphide group having from 1 to 20 carbon atoms, a sulfide group having from 1 to 20 carbon atoms, an acyl group having from 1 to 20 carbon atoms, etc.

The halogen atom includes a chlorine atom, a fluorine atom, a bromine atom, an iodine atom. The hydrocarbon group having from 1 to 20 carbon atoms concretely includes an alkyl group such as a methyl group, an ethyl group, a propyl group, a butyl group, a hexyl group, a cyclohexyl group, an octyl group, etc.; an alkenyl group such as a vinyl group, a propenyl group, a cyclohexenyl group, etc.; an arylalkyl group such as a benzyl group, a phenylethyl group, a phenylpropyl group, etc.; an aryl group such as a phenyl group, a tolyl group, a dimethylphenyl group, a trimethylphenyl group, an ethylphenyl group, a propylphenyl group, a biphenyl group, a naphthyl group, a methylnaphthyl group, an anthracenyl group, a phenanthryl group, etc. Above all, preferred are an alkyl group such as a methyl group, an ethyl group, a propyl group, etc.; and an aryl group such as a phenyl group, etc.

The alkoxy group having from 1 to 20 carbon atoms includes an alkoxy group such as a methoxy group, an ethoxy group, a propoxy group, a butoxy group, etc.; a phenylmethoxy group, a phenylethoxy group, etc. The aryloxy group having from 6 to 20 carbon atoms includes a phenoxy group, a methylphenoxy group, a dimethylphenoxy group, etc. The amide group having from 1 to 20 carbon atoms includes an alkylamide group such as a dimethylamide group, a diethylamide group, dipropylamide group, a dibutylamide group, a dicyclohexylamide group, a methylethylamide group, etc.; an alkenylamide group such as a divinylamide group, a dipropenylamide group, a dicyclohexenylamide group, etc.; an arylalkylamide group such as a dibenzylamide group, a phenylethylamide group, a phenylpropylamide group, etc.; an arylamide group such as a diphenylamide group, a dinaphthylamide group, etc.

The silicon-containing group having from 1 to 20 carbon atoms includes a mono-hydrocarbon-substituted silyl group such as a methylsilyl group, a phenylsilyl group, etc.; a di-hydrocarbon-substituted silyl group such as a dimethylsilyl group, a diphenylsilyl group, etc.; a tri-hydrocarbon-substituted silyl group such as a trimethylsilyl group, a triethylsilyl group, a tripropylsilyl group, a tricyclohexylsilyl group, triphenylsilyl group, a dimethylphenylsilyl group, a methyldiphenylsilyl group, a tritolylsilyl group, a trinaphthylsilyl group, etc.; a hydrocarbon-substituted silyl ether group such as a trimethylsilyl ether group, etc.; a silicon-substituted alkyl group such as a trimethylsilylmethyl group, etc.; a silicon-substituted aryl group such as a trimethylsilylphenyl group, etc. Above all, preferred are a trimethylsilylmethyl group, a phenyldimethylsilylethyl group, etc.

The phosphide group having from 1 to 20 carbon atoms includes an alkylsulfide group such as a methylsulfide group, an ethylsulfide group, a propylsulfide group, a butylsulfide group, a hexylsulfide group, a cyclohexylsulfide group, an octylsulfide group, etc.; an alkenylsulfide group such as a vinylsulfide group, a propenylsulfide group, a cyclohexenylsulfide group, etc.; an arylalkylsulfide group such as a benzylsulfide group, a phenylethylsulfide group, a phenylpropylsulfide group, etc.; an arylsulfide group such as a phenylsulfide group, a tolylsulfide group, a dimethylphenylsulfide group, a trimethylphenylsulfide group, an ethylphenylsulfide group, a propylphenylsulfide group, a biphenylsulfide group, a naphthylsulfide group, a methylnaphthylsulfide group, an anthracenylsulfide group, a phenanthrylsulfide group, etc.

The sulfide group having from 1 to 20 carbon atoms includes an alkylsulfide group such as a methylsulfide group, an ethylsulfide group, a propylsulfide group, a butylsulfide group, a hexylsulfide group, a cyclohexylsulfide group, an octylsulfide group, etc.; an alkenylsulfide group such as a vinylsulfide group, a propenylsulfide group, a cyclohexenylsulfide group, etc.; an arylalkylsulfide group such as a benzylsulfide group, a phenylethylsulfide group, a phenylpropylsulfide group, etc.; an arylsulfide group such as a phenylsulfide group, a tolylsulfide group, a dimethylphenylsulfide group, a trimethylphenylsulfide group, an ethylphenylsulfide group, a propylphenylsulfide group, a biphenylsulfide group, a naphthylsulfide group, a methylnaphthylsulfide group, an anthracenylsulfide group, a phenanthrylsulfide group, etc.

The acyl group having from 1 to 20 carbon atoms includes a formyl group; an alkylacyl such as an acetyl group, a propionyl group, a butyryl group, a valeryl group, a palmitoyl group, a stearoyl group, an oleoyl group, etc.; an arylacyl group such as a benzoyl group, a toluoyl group, a salicyloyl group, a cinnamoyl group, a naphthoyl group, a phthaloyl group, etc.; an oxalyl group, a malonyl group or a succinyl group derived from a dicarboxylic acid such as oxalic acid, malonic acid or succinic acid, etc.

On the other hand, Y represents a Lewis base; plural Y's, if any, may be the same or different, and may crosslink with the other Y, E¹, E² or X. Examples of the Lewis base for Y include amines, ethers, phosphines, thioethers, etc. The amines include amines having from 1 to 20 carbon atoms, concretely alkylamines such as methylamine, ethylamine, propylamine, butylamine, cyclohexylamine, methylethylamine, dimethylamine, diethylamine, dipropylamine, dibutylamine, dicyclohexylamine, methylethylamine, etc; alkenylamines such as vinylamine, propenylamine, cyclohexenylamine, divinylamine, dipropenylamine, dicyclohexenylamine, etc.; arylalkylamines such as phenylamine, phenylethylamine, phenylpropylamine, etc.; arylamines such as diphenylamine, dinaphthylamine, etc.

The ethers include aliphatic simple ether compounds such as methyl ether, ethyl ether, propyl ether, isopropyl ether, butyl ether, isobutyl ether, n-amyl ether, isoamyl ether, etc.; aliphatic composite ether compounds such as methyl ethyl ether, methyl propyl ether, methyl isopropyl ether, methyl n-amyl ether, methyl isoamyl ether, ethyl propyl ether, ethyl isopropyl ether, ethyl butyl ether, ethyl isobutyl ether, ethyl n-amyl ether, ethyl isoamyl ether, etc.; aliphatic unsaturated ether compounds such as vinyl ether, allyl ether, methyl vinyl ether, methyl allyl ether, ethyl vinyl ether, ethyl allyl ether, etc.; aromatic ether compounds such as anisole, phenetol, phenyl ether, benzyl ether, phenyl benzyl ether, α-naphthyl ether, β-naphthyl ether, etc.; cyclic ether compounds such as ethylene oxide, propylene oxide, trimethylene oxide, tetrahydrofuran, tetrahydropyran, dioxane, etc.

The phosphines include phosphines having from 1 to 20 carbon atoms. Concretely, they include alkyl phosphines, for example, mono-hydrocarbon-substituted phosphines such as methyl phosphine, ethyl phosphine, propyl phosphine, butyl phosphine, hexyl phosphine, cyclohexyl phosphine, octyl phosphine, etc.; di-hydrocarbon-substituted phosphines such as dimethyl phosphine, diethyl phosphine, dipropyl phosphine, dibutyl phosphine, dihexyl phosphine, dicyclohexyl phosphine, dioctyl phosphine, etc.; tri-hydrocarbon-substituted phosphines such as trimethyl phosphine, triethyl phosphine, tripropyl phosphine, tributyl phosphine, trihexyl phosphine, tricyclohexyl phosphine, trioctyl phosphine, etc.; monoalkenyl phosphines such as vinyl phosphine, propenyl phosphine, cyclohexenyl phosphine, etc.; dialkenyl phosphines substituted with two alkenyl groups on the hydrogen atoms of phosphine; trialkenyl phosphines substituted with three alkenyl groups on the hydrogen atoms of phosphine; arylalkyl phosphines such as benzyl phosphine, phenylethyl phosphine, phenylpropyl phosphine, etc.; diarylalkyl phosphines or aryldialkyl phosphines substituted with three aryl or alkenyl groups on the hydrogen atoms of phosphine; aryl phosphines, for example, phenyl phosphine, tolyl phosphine, dimethylphenyl phosphine, trimethylphenyl phosphine, ethylphenyl phosphine, propylphenyl phosphine, biphenyl phosphine, naphthyl phosphine, methylnaphthyl phosphine, anthracenyl phosphine, phenanthryl phosphine; di(alkylaryl) phosphines substituted with two alkylaryl groups on the hydrogen atoms of phosphine; tri(alkylaryl) phosphines substituted with three alkylaryl groups on the hydrogen atoms of phosphine; etc. The thioethers include the above-mentioned sulfides.

Next, A¹ and A² each are a divalent crosslinking group that bonds two ligands, representing a hydrocarbon group having from 1 to 20 carbon atoms, a halogen-containing hydrocarbon group having from 1 to 20 carbon atoms, a silicon-containing group, a germanium-containing group, a tin-containing group, —O—, —CO—, —S—, —SO₂—, —Se—, —NR¹—, —PR¹—, —P(O)R¹—, —BR¹— or —AlR¹— where R¹ represents a hydrogen atom, a halogen atom, a hydrocarbon group having from 1 to 20 carbon atoms, or a halogen-containing hydrocarbon group having from 1 to 20 carbon atoms, and they may be the same or different. q indicates an integer of from 1 to 5, and is [(atomic valence of M)−2]; r indicates an integer of from 0 to 3.

Of those crosslinking groups, preferably, at least one is a crosslinking group comprising a hydrocarbon group having at least one carbon atom. The crosslinking group of the type includes, for example, a group of a general formula (a):

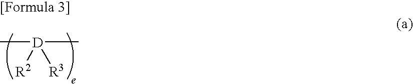

(D represents an element of Group 14 of the Periodic Table, for example, including carbon, silicon, germanium and tin. R² and R³ each represent a hydrogen atom or a hydrocarbon group having from 1 to 20 carbon atoms, and they may be the same or different, or may be bonded to each other to form a cyclic structure. e indicates an integer of from 1 to 4.)

Its examples include a methylene group, an ethylene group, an ethylidene group, a propylidene group, an isopropylidene group, a cyclohexylidene group, a 1,2-cyclohexylene group, a vinylidene group (CH₂═C═), a dimethylsilylene group, diphenylsilylene group, a methylphenylsilylene group, a dimethylgermylene group, a dimethylstannylene group, a tetramethyldisilylene group, a diphenyldisilylene group, etc. Of those, preferred are an ethylene group, an isopropylidene group and a dimethylsilylene group.

Examples of the transition metal compound of the general formula (I) are (1,2′-dimethylsilylene) (2,1′-dimethylsilylene) (3-methylcyclopentadienyl) (3′-methylcyclopentadienyl)zirconium dichloride, (1,2′-dimethylsilylene) (2,1′-isopropylidene)(3-methylcyclopentadienyl) (3′-methylcyclopentadienyl)zirconium dichloride, (1,2′-dimethylsilylene) (2,1′-ethylene) (3-methylcyclopentadienyl) (3′-methylcyclopentadienyl)zirconium dichloride, (1,2′-ethylene) (2,1′-methylene) (3-methylcyclopentadienyl) (3′-methylcyclopentadienyl)zirconium dichloride, (1,2′-ethylene) (2,1′-isopropylidene) (3-methylcyclopentadienyl) (3′-methylcyclopentadienyl)zirconium dichloride, (1,2′-methylene) (2,1′-methylene) (3-methylcyclopentadienyl) (3′-methylcyclopentadienyl)zirconium dichloride, (1,2′-methylene) (2,1′-isopropylidene) (3-methylcyclopentadienyl) (3′-methylcyclopentadienyl)zirconium dichloride, (1,2′-isopropylidene) (2,1′-isopropylidene) (3-methylcyclopentadienyl) (3′-methylcyclopentadienyl)zirconium dichloride, (1,2′-dimethylsilylene) (2,1′-dimethylsilylene) (3,4-dimethylcyclopentadienyl) (3′4′-dimethylcyclopentadienyl)zirconium dichloride, (1,2′-dimethylsilylene) (2,1′-isopropylidene) (3,4-dimethylcyclopentadienyl) (3′4′-dimethylcyclopentadienyl)zirconium dichloride, (1,2′-dimethylsilylene) (2,1′-ethylene) (3,4-dimethylcyclopentadienyl) (3′4′-dimethylcyclopentadienyl)zirconium dichloride,

(1,2′-ethylene) (2,1′-methylene) (3,4-dimethylcyclopentadienyl) (3′4′-dimethylcyclopentadienyl)zirconium dichloride, (1,2′-ethylene) (2,1′-isopropylidene) (3,4-dimethylcyclopentadienyl) (3′4′-dimethylcyclopentadienyl)zirconium dichloride, (1,2′-methylene) (2,1′-methylene) (3,4-dimethylcyclopentadienyl) (3′4′-dimethylcyclopentadienyl)zirconium dichloride, (1,2′-methylene) (2,1′-isopropylidene) (3,4-dimethylcyclopentadienyl) (3′4′-dimethylcyclopentadienyl)zirconium dichloride, (1,2′-isopropylidene) (2,1′-isopropylidene) (3,4-dimethylcyclopentadienyl) (3′4′-dimethylcyclopentadienyl)zirconium dichloride, (1,2′-dimethylsilylene) (2,1′-dimethylsilylene) (3-methyl-5-ethylcyclopentadienyl) (3′-methyl-5′-ethylcyclopentadienyl))zirconium dichloride, (1,2′-dimethylsilylene) (2,1′-dimethylsilylene) (3-methyl-5-ethylcyclopentadienyl) (3′-methyl-5′-ethylcyclopentadienyl))zirconium dichloride, (1,2′-dimethylsilylene) (2,1′-dimethylsilylene) (3-methyl-5-isopropylcyclopentadienyl) (3′-methyl-5′-n-isopropylcyclopentadienyl)zirconium dichloride, (1,2′-dimethylsilylene) (2,1′-dimethylsilylene) (3-methyl-5-n-butylcyclopentadienyl) (3′-methyl-5′-n-butylcyclopentadienyl)zirconium dichloride, (1,2′-dimethylsilylene) (2,1′-dimethylsilylene) (3-methyl-5-phenylcyclopentadienyl) (3′-methyl-5′-phenylcyclopentadienyl)zirconium dichloride,

(1,2′-dimethylsilylene) (2,1′-isopropylidene) (3-methyl-5-ethylcyclopentadienyl) (3′-methyl-5′-ethylcyclopentadienyl)zirconium dichloride, (1,2′-dimethylsilylene) (2,1′-isopropylidene) (3-methyl-5-isopropylcyclopentadienyl) (3′-methyl-5′-isopropylcyclopentadienyl)zirconium dichloride, (1,2′-dimethylsilylene) (2,1′-isopropylidene) (3-methyl-5-n-butylcyclopentadienyl) (3′-methyl-5′-n-butylcyclopentadienyl)zirconium dichloride, (1,2′-dimethylsilylene) (2,1′-isopropylidene) (3-methyl-5-phenylcyclopentadienyl) (3′-methyl-5′-phenylcyclopentadienyl)zirconium dichloride, (1,2′-dimethylsilylene) (2,1′-ethylene) (3-methyl-5-ethylcyclopentadienyl) (3′-methyl-5′-ethylcyclopentadienyl)zirconium dichloride, (1,2′-dimethylsilylene) (2,1′-ethylene) (3-methyl-5-isopropylcyclopentadienyl) (3′-methyl-5′-isopropylcyclopentadienyl)zirconium dichloride, (1,2′-dimethylsilylene) (2,1′-ethylene) (3-methyl-5-n-butylcyclopentadienyl) (3′-methyl-5′-n-butylcyclopentadienyl) zirconium dichloride, (1,2′-dimethylsilylene)(2,1′-ethylene) (3-methyl-5-phenylcyclopentadienyl) (3′-methyl-5′-phenylcyclopentadienyl)zirconium dichloride, (1,2′-dimethylsilylene) (2,1′-methylene) (3-methyl-5-ethylcyclopentadienyl) (3′-methyl-5′-ethylcyclopentadienyl)zirconium dichloride,

(1,2′-dimethylsilylene) (2,1′-methylene) (3-methyl-5-isopropylcyclopentadienyl) (3′-methyl-5′-isopropylcyclopentadienyl)zirconium dichloride, (1,2′-dimethylsilylene) (2,1′-methylene) (3-methyl-5-n-butylcyclopentadienyl) (3′-methyl-5′-n-butylcyclopentadienyl)zirconium dichloride, (1,2′-dimethylsilylene) (2,1′-methylene) (3-methyl-5-phenylcyclopentadienyl) (3′-methyl-5′-phenylcyclopentadienyl)zirconium dichloride, (1,2′-ethylene) (2,1′-methylene) (3-methyl-5-isopropylcyclopentadienyl) (3′-methyl-5′-isopropylcyclopentadienyl)zirconium dichloride, (1,2′-ethylene) (2,1′-isopropylidene) (3-methyl-5-isopropylcyclopentadienyl) (3′-methyl-5′-isopropylcyclopentadienyl)zirconium dichloride, (1,2′-methylene) (2,1′-methylene) (3-methyl-5-isopropylcyclopentadienyl) (3′-methyl-5′-isopropylcyclopentadienyl)zirconium dichloride, (1,2′-methylene) (2,1′-isopropylidene) (3-methyl-5-isopropylcyclopentadienyl) (3′-methyl-5′-isopropylcyclopentadienyl)zirconium dichloride, and those derived from these by substituting zirconium therein with titanium or hafnium, and compounds of a general formula (II) to be mentioned below. In addition, also mentioned are similar compounds with a metal element of any other Group. Preferred are transition metal compound with a metal of Group 4 of the Periodic Table; and more preferred are those with zirconium.

Of the above-mentioned transition metal compounds of the general formula (I), preferred are compounds of a general formula (II):

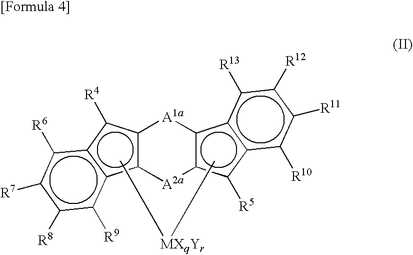

In above general formula (II), M represents a metal element of Groups 3 to 10 of the Periodic Table; A^{1a} and A^{2a} each represent the crosslinking group of the general formula (a) in the general formula (I), preferably CH₂, CH₂CH₂, (CH₃)₂C, (CH₃)₂C(CH₃)₂C, (CH₃)₂Si or (C₆H₅)₂Si. A^{1a} and A^{2a} may be the same or different. R⁴ to R¹³ each represent a hydrogen atom, a halogen atom, a hydrocarbon group having from 1 to 20 carbon atoms, a halogen-containing hydrocarbon group having from 1 to 20 carbon atoms, a silicon-containing group, or a hetero atom-containing group. As the halogen atom, the hydrocarbon group having from 1 to 20 carbon atoms and the silicon-containing group, mentioned are the same as those mentioned in the above for the general formula (I). The halogen-containing hydrocarbon group having from 1 to 20 carbon atoms includes a p-fluorophenyl group, a 3,5-difluorophenyl group, a 3,4,5-trifluorophenyl group, a pentafluorophenyl group, a 3,5-bis(trifluoro)phenyl group, a fluorobutyl group, etc. The hetero atom-containing group includes a hetero atom-containing group having from 1 to 20 carbon atoms, concretely a nitrogen-containing group such as a dimethylamino group, a diethylamino group, a diphenylamino group, etc.; a sulfur-containing group such as a phenylsulfide group, a methylsulfide group, etc.; a phosphorus-containing group such as a dimethylphosphino group, a diphenylphosphino group, etc.; an oxygen-containing group such as a methoxy group, an ethoxy group, a phenoxy group, etc. Above all, for R⁴ and R⁵, preferred is a group containing a hetero atom such as halogen, oxygen, silicon or the like, as bringing about high polymerization activity. For R⁶ to R¹³, preferred is a hydrogen atom or a hydrocarbon group having from 1 to 20 carbon atoms. X and Y are the same as in the general formula (I). q is an integer of from 1 to 5, indicating [(atomic valence of M)−2]; and r indicates an integer of from 0 to 3.

Of the transition metal compounds of the general formula (II), compounds with a transition metal of Group 4 of the Periodic Table where the two indenyl groups are the same include (1,2′-dimethylsilylene) (2,1′-dimethylsilylene)bis(indenyl)zirconium dichloride, (1,2′-dimethylsilylene) (2,1′-dimethylsilylene)bis(3-methylindenyl)zirconium dichloride, (1,2′-dimethylsilylene) (2,1′-dimethylsilylene)bis(3-ethylindenyl)zirconium dichloride, (1,2′-dimethylsilylene) (2,1′-dimethylsilylene)bis(3-isopropylindenyl)zirconium dichloride, (1,2′-dimethylsilylene) (2,1′-dimethylsilylene)bis(3-trimethylsilylmethylindenyl)zirconium dichloride, (1,2′-dimethylsilylene) (2,1′-dimethylsilylene)bis(3-butylindenyl)zirconium dichloride, (1,2′-dimethylsilylene) (2,1′-dimethylsilylene)bis(4-methylindenyl)zirconium dichloride, (1,2′-dimethylsilylene) (2,1′-dimethylsilylene)bis(4,7-dimethylindenyl)zirconium dichloride, (1,2′-dimethylsilylene) (2,1′-dimethylsilylene)bis(5,6-dimethylindenyl)zirconium dichloride, (1,2′-dimethylsilylene) (2,1′-dimethylsilylene)bis(3-ethoxymethylindenyl)zirconium dichloride, (1,2′-dimethylsilylene) (2,1′-dimethylsilylene)bis(3-ethoxyethylindenyl)zirconium dichloride,

(1,2′-dimethylsilylene) (2,1′-dimethylsilylene)bis(3-methoxymethylindenyl)zirconium dichloride, (1,2′-dimethylsilylene) (2,1′-dimethylsilylene)bis(3-methoxyethylindenyl)zirconium dichloride, (1,2′-phenylmethylsilylene) (2,1′-phenylmethylsilylene)bis(indenyl)zirconium dichloride, (1,2′-phenylmethylsilylene) (2,1′-phenylmethylsilylene)bis(3-methylindenyl)zirconium dichloride, (1,2′-dimethylsilylene) (2,1′-isopropylidene)bis(indenyl)zirconium dichloride, (1,2′-dimethylsilylene) (2,1′-isopropylidene)bis(3-methylindenyl)zirconium dichloride, (1,2′-dimethylsilylene) (2,1′-isopropylidene)bis(3-isopropylindenyl)zirconium dichloride, (1,2′-dimethylsilylene) (2,1′-isopropylidene)bis(3-n-butylindenyl)zirconium dichloride, (1,2′-dimethylsilylene) (2,1′-isopropylidene)bis(3-trimethylsilylmethylindenyl)zirconium dichloride, (1,2′-dimethylsilylene) (2,1′-isopropylidene)bis(3-trimethylsilylindenyl)zirconium dichloride, (1,2′-dimethylsilylene) (2,1′-isopropylidene)bis(3-phenylindenyl)zirconium dichloride, (1,2′-dimethylsilylene) (2,1′-methylene)bis(indenyl)zirconium dichloride,

(1,2′-dimethylsilylene) (2,1′-methylene)bis(3-methylindenyl)zirconium dichloride, (1,2′-dimethylsilylene) (2,1′-methylene)bis(3-isopropylindenyl)zirconium dichloride, (1,2′-dimethylsilylene) (2,1′-methylene)bis(3-n-butylindenyl)zirconium dichloride, (1,2′-dimethylsilylene) (2,1′-methylene)bis(3-trimethylsilylmethylindenyl)zirconium dichloride, (1,2′-dimethylsilylene) (2,1′-methylene)bis(3-trimethylsilylindenyl)zirconium dichloride, (1,2′-diphenylsilylene) (2,1′-methylene)bis(indenyl)zirconium dichloride, (1,2′-diphenylsilylene) (2,1′-methylene)bis(3-methylindenyl)zirconium dichloride, (1,2′-diphenylsilylene) (2,1′-methylene)bis(3-n-butylindenyl)zirconium dichloride, (1,2′-diphenylsilylene) (2,1′-methylene)bis(3-trimethylsilylmethylindenyl)zirconium dichloride, (1,2′-diphenylsilylene) (2,1′-methylene)bis(3-trimethylsilylindenyl)zirconium dichloride, and those derived from these compounds by substituting zirconium therein with titanium or hafnium; however, the present invention should not be limited to them. In addition, also mentioned are similar compounds with a metal element of any other Group than Group 4. Preferred are transition metal compounds with a metal of Group 4 of the Periodic Table; and more preferred are those with zirconium.

On the other hand, of the transition metal compounds of the general formula (II), transition metal compounds with a metal of Group 4 of the Periodic Table where R⁵ is a hydrogen atom and R⁴ is not a hydrogen atom include (1,2′-dimethylsilylene) (2,1′-dimethylsilylene) (indenyl) (3-trimethylsilylmethylindenyl)zirconium dichloride, (1,2′-dimethylsilylene) (2,1′-dimethylsilylene) (indenyl) (3-methylindenyl)zirconium dichloride, (1,2′-dimethylsilylene) (2,1′-dimethylsilylene) (indenyl) (3-trimethylsilylindenyl)zirconium dichloride, (1,2′-dimethylsilylene) (2,1′-dimethylsilylene) (indenyl) (3-phenylindenyl)zirconium dichloride, (1,2′-dimethylsilylene) (2,1′-dimethylsilylene) (indenyl) (3-benzylindenyl)zirconium dichloride, (1,2′-dimethylsilylene) (2,1′-dimethylsilylene) (indenyl) (3-neopentylindenyl)zirconium dichloride, (1,2′-dimethylsilylene) (2,1′-dimethylsilylene) (indenyl) (3-phenethylindenyl)zirconium dichloride, (1,2′-ethylene) (2,1′-ethylene) (indenyl) (3-trimethylsilylmethylindenyl)zirconium dichloride, (1,2′-ethylene) (2,1′-ethylene) (indenyl) (3-methylindenyl)zirconium dichloride, (1,2′-ethylene) (2,1′-ethylene) (indenyl) (3-trimethylsilylindenyl)zirconium dichloride, (1,2′-ethylene) (2,1′-ethylene) (indenyl) (3-phenylindenyl)zirconium dichloride, (1,2′-ethylene) (2,1′-ethylene) (indenyl) (3-benzylindenyl)zirconium dichloride, (1,2′-ethylene) (2,1′-ethylene) (indenyl) (3-neopentylindenyl)zirconium dichloride, (1,2′-ethylene) (2,1′-ethylene) (indenyl) (3-phenethylindenyl)zirconium dichloride, and those derived from these compounds by substituting zirconium therein with titanium or hafnium; however, the present invention should not be limited to them. In addition, also mentioned are similar compounds with a metal element of any other Group than Group 4. Preferred are transition metal compounds with a metal of Group 4 of the Periodic Table; and more preferred are those with zirconium.

The compound (B) capable of reacting with the transition metal compound to form an ionic complex, which constitutes the catalyst for use in the present invention, is preferably a borate compound from the viewpoint that a highly-pure, terminal-unsaturated olefin polymer having a relatively low molecular weight can be produced and from the viewpoint that the catalyst may have a high catalyst activity. The borate compound includes triethylammonium tetraphenylborate, tri-n-butylammonium tetraphenylborate, trimethylammonium tetraphenylborate, tetraethylammonium tetraphenylborate, methyl(tri-n-butyl)ammonium tetraphenylborate, benzyl(tri-n-butyl)ammonium tetraphenylborate, dimethyldiphenylammonium tetraphenylborate, triphenyl(methyl)ammonium tetraphenylborate, trimethylanilinium tetraphenylborate, methylpyridinium tetraphenylborate, benzylpyridinium tetraphenylborate, methyl(2-cyanopyridinium) tetraphenylborate, triethylammonium tetrakis(pentafluorophenyl)borate, tri-n-butylammonium tetrakis(pentafluorophenyl)borate, triphenylammonium tetrakis(pentafluorophenyl)borate, tetra-n-butylammonium tetrakis(pentafluorophenyl)borate, tetraethylammonium tetrakis(pentafluorophenyl)borate, benzyl(tri-n-butyl)ammonium tetrakis(pentafluorophenyl)borate, methyldiphenylammonium tetrakis(pentafluorophenyl)borate, triphenyl(methyl)ammonium tetrakis(pentafluorophenyl)borate, methylanilinium tetrakis(pentafluorophenyl)borate, dimethylanilinium tetrakis(pentafluorophenyl)borate, trimethylanilinium tetrakis(pentafluorophenyl)borate,

methylpyridinium tetrakis(pentafluorophenyl)borate, benzylpyridinium tetrakis(pentafluorophenyl)borate, methyl(2-cyanopyridinium) tetrakis(pentafluorophenyl)borate, benzyl(2-cyanopyridinium) tetrakis(pentafluorophenyl)borate, methyl(4-cyanopyridinium) tetrakis(pentafluorophenyl)borate, triphenylphosphonium tetrakis(pentafluorophenyl)borate, dimethylanilinium tetrakis[bis(3,5-ditrifluoromethyl)phenyl]borate, ferrocenium tetraphenylborate, silver tetraphenylborate, trityl tetraphenylborate, tetraphenylporphyrin manganese tetraphenylborate, triphenylcarbenium tetrakis(pentafluorophenyl)borate, methylanilinium tetrakis(perfluorophenyl)borate, ferrocenium tetrakis(pentafluorophenyl)borate, (1,1-dimethylferrocenium) tetrakis(pentafluorophenyl)borate, decamethylferrocenium tetrakis(pentafluorophenyl)borate, silver tetrakis(pentafluorophenyl)borate, trityl tetrakis(pentafluorophenyl)borate, lithium tetrakis(pentafluorophenyl)borate, sodium tetrakis(pentafluorophenyl)borate, tetraphenylporphyrin manganese tetrakis(pentafluorophenyl)borate, silver tetrafluoroborate, etc. One or more of these may be used either singly or as combined. In case where the molar ratio of hydrogen to the transition metal compound (hydrogen/transition metal compound) to be mentioned below is 0 (zero), preferred are dimethylanilinium tetrakis(pentafluorophenyl)borate, triphenylcarbenium tetrakis(pentafluorophenyl)borate, methylanilinium tetrakis(perfluorophenyl)borate, etc.

The catalyst for use in the production method of the present invention may be a combination of the above-mentioned ingredient (A) and ingredient (B), or it may further contain an organoaluminium compound as an ingredient (C) in addition to the above-mentioned ingredient (A) and ingredient (B).

The organoaluminium compound of the ingredient (C) includes trimethylaluminium, triethylaluminium, tri-isopropylaluminium, tri-isobutylaluminium, tri-normal-hexylaluminium, tri-normal-octylaluminium, dimethylaluminium chloride, diethylaluminium chloride, methylaluminium dichloride, ethylaluminium dichloride, dimethylaluminium fluoride, diisobutylaluminium hydride, diethylaluminium hydride, ethylaluminium sesqui-chloride, etc. One or more of these organoaluminium compounds may be used either singly or as combined.

Of those, preferred in the present invention are trialkylaluminiums such as trimethylaluminium, triethylaluminium, tri-isopropylaluminium, tri-isobutylaluminium, tri-normal-hexylaluminium, tri-normal-octylaluminium, etc.; more preferred are tri-isobutylaluminium, tri-normal-hexylaluminium and tri-normal-octylaluminium.

The amount of the ingredient (A) to be used is generally from 0.1×10⁻⁶ to 1.5×10⁻⁵ mol/L, preferably from 0.15×10⁻⁶ to 1.3×10⁻⁵ mol/L, more preferably from 0.2×10⁻⁶ to 1.2×10⁻⁵ mol/L, even more preferably from 0.3×10⁻⁶ to 1.0×10⁻⁵ mol/L. When the amount of the ingredient (A) to be used is at least 0.1×10⁻⁶ mol/L, then the catalyst may exhibit sufficiently the catalyst activity; and when at most 1.5×10⁻⁵ mol/L, then the polymerization heat may be readily removed.

The ratio in use of the ingredient (A) to the ingredient (B), (A)/(B) by mol is preferably from 10/1 to 1/100, more preferably from 2/1 to 1/10. When (A)/(B) falls within a range of from 10/1 to 1/100, then the catalyst can exhibit its effect and, in addition, the catalyst cost pre the unit mass of polymer may be reduced. Further, there is no risk of presence of much boron in the intended, terminal-unsaturated olefin polymer.

The ratio in use of the ingredient (A) to the ingredient (C), (A)/(C) by mol is preferably from 1/1 to 1/10000, more preferably from 1/5 to 1/2000, even more preferably from 1/10 to 1/1000. The ingredient (C), if any in the catalyst, may enhance the polymerization activity per transition metal of the catalyst. When (A)/(C) falls within a range of from 1/1 to 1/10000, then the balance between the effect of the ingredient (C) added and the economic aspect of the catalyst, and in addition, there is no risk of presence of much aluminium in the intended, terminal-unsaturated olefin polymer.

In the production method of the present invention, the ingredient (A) and the ingredient (B), or the ingredient (A), the ingredient (B) and the ingredient (C) may be processed for pre-contact. The pre-contact may be attained, for example, by contacting the ingredient (A) with the ingredient (B); however, the method is not specifically defined, and any known method is employable. The pre-contact may enhance the catalyst activity, or may be effective for catalyst cost reduction by reducing the amount of the catalyst promoter, the ingredient (B) to be used.

The terminal-unsaturated olefin polymer of the present invention may be produced through polymerization in the presence of the above-mentioned catalyst in a molar ratio of hydrogen to the transition metal compound (hydrogen/transition metal compound) of from 0 to 10000. When hydrogen/transition metal compound is 0, then the compound (B) capable of reacting with the transition metal compound to form an ionic complex is preferably methylanilinium tetrakis(perfluorophenyl)borate, dimethylanilinium tetrakis(pentafluorophenyl)borate or triphenylcarbenium tetrakis(pentafluorophenyl)borate, as so mentioned in the above.

In general, it is known that hydrogen functions as a molecular weight-controlling agent or a chain transfer agent and the polymer chain terminal is a saturated structure. Specifically, since hydrogen functions as a molecular weight-controlling agent or a chain transfer agent, the molecular weight of the polymer produced may monotonously lower in accordance with the amount thereof added and the degree of unsaturation of the polymer terminal greatly lowers. In addition, it is also known that hydrogen reactivates a dormant and therefore has a function of catalyst activity enhancement. In general, when hydrogen is used for such purposes, the molar ratio of hydrogen to the transition metal compound may fall within a range of from 13000 to 100000.

In the present invention, the influence of minor hydrogen (The molar ratio, hydrogen/transition metal compound, is at most 10000) on the catalyst potency is not clear, but when hydrogen is used within a specific range as above, then it may enhance the terminal vinylidene selectivity and the activity. Specifically, the present invention has been completed by the findings of (1) the presence of a minor hydrogen addition region within which hydrogen addition does not change the molecular weight of the polymer produced, (2) the presence of a minor hydrogen addition region within which the catalyst activity is improved, the catalyst residue in the polymer decreases and the polymer has high purity, and (3) the presence of a minor hydrogen addition region within which the vinylidene group purity in the terminal unsaturated group increases.

The molar ratio of hydrogen to the transition metal compound (hydrogen/transition metal compound) is preferably from 10 to 9000, more preferably from 20 to 8000, even more preferably from 40 to 7000, still more preferably from 200 to 4500, further more preferably from 300 to 4000, most preferably from 400 to 3000. When the molar ratio is at most 10000, then production of a polyolefin polymer having an extremely low degree of terminal unsaturation may be prevented, and the intended, highly-pure, terminal-unsaturated polyolefin polymer can be produced. As compared with a case where the molar ratio is 0, the content of the terminal vinylidene group in the polymer produced may be increased owing to the presence of minor hydrogen. As the other terminal unsaturated group than the terminal vinylidene group, there may be mentioned a terminal vinyl group; however, when the polymer containing a terminal vinyl group is used as a reactive precursor in producing a modified polymer through radical polymerization modification, there may often occur a problem of modification reduction. In such a case, presence of minor hydrogen is favorable as capable of preventing the increase in the number of terminal vinyl groups and capable of lowering the amount of the terminal vinyl groups to be formed.

The terminal vinyl group may be quantitatively determined according to the method described in the paragraph [0012]. The proportion (%) of the terminal vinyl group to the unsaturated group may be computed according to the following formula:

(D)/[(C)+(D)]×100 unit, %

The proportion of the terminal vinyl group to the unsaturated group is preferably at most 15%, more preferably at most 10%, even more preferably at most 8%, most preferably from 0 to 5%.

As described in the above, the polymerization is attained preferably in the presence of minor hydrogen for increasing the terminal vinylidene group selectivity and the catalyst activity. The effect of the minor hydrogen addition is demonstrated in Examples. Contrary to the conventional expectation, the molecular weight of the polymer produced did not lower, and the activity greatly increased and the terminal vinylidene group selectivity also greatly increased. In addition, the amount of the terminal vinyl group formed decreased. On the other hand, use of much hydrogen resulted in ordinary behavior.

The polymerization method in producing the terminal-unsaturated olefin polymer is not specifically defined, for which, however, preferred are solution polymerization and bulk polymerization. Any of a batch process and a continuous process is applicable to the polymerization method. The solvent usable in solution polymerization includes saturated hydrocarbon solvents such as hexane, heptane, butane, octane, isobutane, etc.; alicyclic hydrocarbon solvents such as cyclohexane, methylcyclohexane, etc.; aromatic hydrocarbon solvents such as benzene, toluene, xylene, etc.

Of the highly-pure, terminal-unsaturated olefin polymer of the present invention, the intrinsic viscosity [η], the molecular weight distribution (Mw/Mn), the mesopentad fraction [mmmm] and the melting point (Tm) can be controlled according to the methods mentioned below.

The intrinsic viscosity [η] can be controlled by changing ordinary polymerization conditions. The intrinsic viscosity may be increased by any one or more factors: polymerization temperature depression, olefin monomer concentration increase attained by polymerization pressure increase or the like, and transition metal catalyst amount reduction; and for lowering the intrinsic viscosity, the control factors shall be set oppositely to the above.

In general, the molecular weight distribution (Mw/Mn) may be determined almost by the catalyst to be used, and Mw/Mn may fall within a range of from 1.5 to 2.5 or so. For molecular weight distribution control, the polymerization may be attained in multiple stages, and the molecular weight of the polymer to be produced in each stage may be varied. Specifically, for broadening the molecular weight distribution, the production may be attained in multiple stages, and in every stage, the polymerization temperature and the monomer concentration are varied to thereby produce a polymer having a high molecular weight and a polymer having a lower molecular weight in a reactor. The molecular weight distribution of the polymer of the present invention, produced according to the above-mentioned production method, is at most 4.

The mesopentad fraction [mmmm] can be controlled through selection of the catalyst and through selection of the polymerization condition. A polymer having a low mesopentad fraction may be produced by the use of a highly-symmetric catalyst in which the ligands are the same in the type of the substituent and the position thereof, as in Example 1 to be given hereinunder. When a catalyst where the ligands differ in the type of the substituent and the position thereof or where one ligand alone has a substituent is used, a polymer having a higher tacticity can be produced. Further, when a catalyst where the ligand does not have any other substituent than the crosslinking agent is used, a polymer having a highest tacticity can be produced. This is described in more detail. Precisely, for [mmmm]<50, preferred are those of the transition metal compound of the general formula (II) where the two indenyl groups have the same substituent; and more preferred are (1,2′-dimethylsilylene) (2,1′-dimethylsilylene)bis(3-isopropylindenyl)zirconium dichloride, (1,2′-dimethylsilylene) (2,1′-dimethylsilylene)bis(3-trimethylsilylmethylindenyl)zirconium dichloride, (1,2′-dimethylsilylene) (2,1′-dimethylsilylene)bis(3-butylindenyl)zirconium dichloride, (1,2′-dimethylsilylene) (2,1′-dimethylsilylene)bis(4-methylindenyl)zirconium dichloride. For [mmmm] of from 50 to 65, preferred are those of the transition metal compound of the general formula (II) where R⁵ is a hydrogen atom, R⁴ is a substituent except a hydrogen atom; and more preferred are those where R⁴ is a bulky substituent. The bulky substituent includes a trimethylsilylmethyl group, a trimethylsilyl group, a phenyl group, a benzyl group, a neopentyl group, a phenethyl group, etc. For [mmmm]>65, preferred are those of the transition metal compound of the formula (II) where the two indenyl groups are unsubstituted; and more preferred are (1,2′-dimethylsilylene) (2,1′-dimethylsilylene)bis(indenyl)zirconium dichloride, and its derivatives where the crosslinking group, dimethylsilylene group is substituted with a substituent selected from a phenylmethylsilylene group, a diphenylsilylene group and a methylene group.

The factor of polymerization condition includes a polymerization temperature and an olefin monomer concentration. The mesopentad fraction may be increased by lowering the polymerization temperature, and by increasing the olefin monomer concentration to be attained by polymerization pressure increase.

The melting point (Tm) and the mesopentad fraction [mmmm] has the following relationship:

1.76[mmmm]−25.0≦Tm≦1.76[mmmm]+5.0,

and the mesopentad fraction is a control factor for the melting point. Accordingly, by almost controlling the mesopentad fraction, the melting point may be controlled. The above relational formula is derived from the relation between the tacticity [mmmm] and the melting point (Tm) of the polymer. In general, the relation between the mean tacticity to be detected and the melting point (Tm) of a polyolefin having a moiety with high tacticity and a moiety with low tacticity or with no tacticity, or a mixture of a polyolefin having tacticity and a polyolefin having low tacticity or not having tacticity is toward the tendency of low tacticity and high melting point. On the other hand, the polymer satisfying the above-mentioned relational formula is a polymer having a highly-uniform tacticity distribution, and therefore, the above relational formula can be an index of the uniformity of the tacticity distribution of the polymer.

In case where the catalyst where the ligands differ in the type of the substituent and the position thereof or where one ligand alone has a substituent is used, it is possible to form heterogeneous bonding such as 2,1-insertion or 1,3-insertion, or to change the tacticity through multistage polymerization to thereby enlarge the tacticity distribution, and therefore, based on these control factors, the melting point of the polymer may be controlled while the tacticity thereof is kept the same.

In the highly-pure, terminal-unsaturated olefin polymer of the present invention, in order that the transition metal content derived from the catalyst is at most 10 ppm by mass, the aluminium content is at most 300 ppm by mass and the boron content is at most 10 ppm by mass, the catalyst activity for the polymer must be high.

Using the selected (A) and (B), or (A), (B) and (C) in a ratio of hydrogen/(A) of from 0 to 10000, and selecting the polymerization condition, the catalyst activity can be increased. The factors are, in general, the polymerization temperature, the olefin monomer temperature and the polymerization time. The polymerization temperature is generally from 20 to 150° C. When overstepping the range, the catalyst activity may lower. The polymerization temperature is preferably from 30 to 130° C., more preferably from 40 to 100° C.

The olefin monomer concentration is preferably higher, and in general, it may be at least 0.05 mol/L, including bulk polymerization where the olefin monomer serves also as a solvent. When the olefin monomer concentration is less than 0.05 mol/L, then the catalyst activity may lower.

In producing the highly-pure, terminal-unsaturated olefin polymer, the conditions capable of sufficiently expressing the catalyst activity are defined, and then the control factors for the intrinsic viscosity [η], the molecular weight distribution (Mw/Mn), the mesopentad fraction [mmmm] and the melting point (Tm) are varied. One example of the process of defining the production conditions is mentioned below.

### (1) Catalyst Selection:

The ingredient (A) that is expected to have a desired tacticity within its control range is selected.

### (2) Determination of the Amount of Minor Hydrogen to be Added:

Using the ingredient (A) selected in the above (1), the amount of hydrogen to be added for satisfying the desired terminal vinylidene group is determined.

### (3) Tacticity Control:

The hydrogen amount to be added is fixed, and two points of polymerization conditions satisfying the desired tacticity are determined. Concretely, production conditions for the polymer having a desired tacticity are determined as combinations of the conditions that differ in the polymerization temperature and the monomer concentration. In this step, the conditions are so determined that the desired molecular weight of the polymer could be within the range of the above two points.

### (4) Molecular Weight Control:

Based on the polymerization conditions of the above (3), the reaction condition is controlled and the molecular weight of the polymer is thereby controlled. For increasing the molecular weight, the condition may be controlled by lowering the production temperature or by increasing the monomer concentration or by the combination of the two. For lowering the molecular weight, the condition may be controlled by elevating the production temperature or by lowering the monomer concentration or by the combination of the two.

Using the production conditions determined according to the above-mentioned method and controlling the polymerization time, the polymer of the present invention can be produced. The polymerization time may be generally from 1 minute to 20 hours or so, preferably from 5 minutes to 15 hours, more preferably from 10 minutes to 10 hours, even more preferably from 20 minutes to 8 hours. When the polymerization time is shorter than 1 minute, then the amount of the terminal-unsaturated olefin polymer to be produced may be small, and the catalyst reside may increase. When longer than 20 hours, then the catalyst activity may lower and the production of the terminal-unsaturated olefin polymer may be substantially stopped.

### EXAMPLES

Next, the present invention is described in more detail with reference to the following Examples; however, the present invention should not be limited at all by these Examples.

### Example 1

### Production of Propylene Homopolymer

### (1) Synthesis of Metal Complex

In the manner mentioned below, (1,2′-dimethylsilylene) (2,1′-dimethylsilylene)-bis(3-trimethylsilylmethylindenyl)zirconium dichloride was synthesized.

In a Schlenk bottle, (1,2′-dimethylsilylene) (2,1′-dimethylsilylene)-bis(indene) lithium salt (3.0 g, 6.97 mmol) was dissolved in THF (tetrahydrofuran) (50 ml) and cooled to −78° C. Iodomethyltrimethylsilane (2.1 ml, 14.2 mmol) was gradually dropwise added thereto, and stirred at room temperature for 12 hours.

The solvent was evaporated away, ether (50 ml) was added followed by washing with saturated ammonium chloride solution. After liquid-liquid separation, the organic phase was dried to remove the solvent thereby giving (1,2′-dimethylsilylene) (2,1′-dimethylsilylene)-bis(3-trimethylsilylmethylindene) (3.04 g, 5.88 mmol) (yield 84%).

Next, in a nitrogen current, (1,2′-dimethylsilylene) (2,1′-dimethylsilylene)-bis(3-trimethylsilylmethylindene) (3.04 g, 5.88 mmol) produced in the above and ether (50 ml) were put into a Schlenk bottle. This was cooled to −78° C., and n-BuLi/hexane solution (1.54 M, 7.6 ml, 1.7 mmol)) was dropwise added. This was heated up to room temperature and stirred for 12 hours, and then ether was evaporated away. The resulting solid was washed with hexane (40 ml) to give an ether-added lithium salt (3.06 g, 5.07 mol) (yield 73%).

The data of ¹H-NMR (90 MHz, THF-d₈) were as follows:

δ: 0.04 (s, 18H, trimethylsilyl), 0.48 (s, 12H, dimethylsilylene), 1.10 (t, 6H, methyl), 2.59 (s, 4H, methylene), 3.38 (q, 4H, methylene), 6.2-7.7 (m, 8H, Ar—H).

In a nitrogen current, the lithium salt produced in the above was dissolved in toluene (50 ml). This was cooled to −78° C., and a toluene (20 ml) suspension of zirconium tetrachloride (1.2 g, 5.1 mmol) previously cooled to −78° C. was dropwise added thereto. After the addition, this was stirred at room temperature for 6 hours. The solvent was evaporated away from the reaction solution. The resulting residue was recrystallized with dichloromethane to give (1,2′-dimethylsilylene) (2,1′-dimethylsilylene)-bis(3-trimethylsilylmethylindenyl)zirconium dichloride (0.9 g, 1.33 mmol) (yield 26%).

The data of ¹H-NMR (90 MHz, CDCl₃) were as follows:

δ: 0.0 (s, 18H, trimethylsilyl), 1.02, 1.12 (s, 12H, dimethylsilyl), 2.51 (dd, 4H, methylene), 7.1-7.6 (m, 8H, Ar—H).

### (2) Polymerization of Propylene

Dry heptane (0.4 L), triisobutylaluminium (0.5 mmol)/heptane solution (1 ml), and methylanilinium tetrakis(perfluorophenyl)borate (1.5 μmol)/heptane slurry (2 ml) were put in a stainless steel-made autoclave having an inner capacity of 1.4 L and dried by heating, and stirred for 10 minutes while controlled at 50° C. A heptane slurry (2 ml) of (1,2′-dimethylsilylene) (2,1′-dimethylsilylene)-bis(3-trimethylsilylmethylindenyl)zirconium dichloride (0.5 μmol) prepared in the above (1) was put into it.

Next, the temperature was elevated up to 70° C. with stirring, and propylene gas was introduced up to 0.8 MPa as the total pressure. During the polymerization reaction, propylene gas was kept introduced via a pressure controller so that the pressure could be kept constant, to attain the polymerization for 120 minutes, and then this was cooled, the unreacted propylene was removed by degassing, and the contents were taken out. The contents were dried in air, further dried under reduced pressure at 80° C. for 8 hours to give polypropylene (123 g). The produced polypropylene was analyzed for the physical properties thereof according to the method mentioned below. The polymerization conditions are shown in Table 1; and the evaluation results on polymerization are in Table 2. In Table 2, “ppm” means “ppm by mass”.

### (1) Intrinsic Viscosity [η]:

This is measured in a solvent tetralin at 135° C., using an automatic viscometer, Rigo's VMR-053 Model.

Using an Ubbelohde viscometer, the reduced viscosity (η_{SP}/c) of the polymer is measured in decalin at 135° C., and the intrinsic viscosity [η] thereof is computed according to the following formula (Huggins formula):

η_{SP}/c=[η]+K[η]²c,

η_{SP}/c (dl/g): reduced viscosity,
[η] (dl/g): intrinsic viscosity,
c (g/dl): polymer concentration,
K=0.35 (Huggins constant).

### (2) Molecular Weight Distribution:

As mentioned in the above, the molecular weight distribution (Mw/Mn) is determined by measuring the weight-average molecular weight (Mw) and the number-average molecular weight (Mn) of the polymer, based on polystyrene, through gel permeation chromatography (GPC).

### (3) Terminal Vinylidene Content Per Molecule:

Computed according to the above-mentioned method.

(4) Mesopentad fraction [mmmm], racemi-meso-racemi-meso fraction [rmrm], meso-meso-racemi-racemi fraction [mm] and racemi-meso-meso-racemi fraction [rmmr]:

Measured according to the above-mentioned method.

### (5) Melting Point (Tm):

Determined through DSC as in the above.

(6) Transition metal, aluminium and boron content:

Using an electric furnace, the polymer is ashed, and dissolved in an aqueous mixed sulfuric acid/hydrofluoric acid solution. Then, its volume is made constant with an aqueous hydrochloric acid solution (2 mol/L), and after optionally diluted, this is analyzed with ICP (high-frequency induction-coupled plasma spectrometer). The data overstepping the detection limit are considered as “less than 1 ppm by mass”, and on the presumption that all the catalyst component remained in the polymer, the computed data are shown.

### (7) Proportion (%) of Terminal Vinyl Group to Unsaturated Group:

Computed according to the above-mentioned method.

### Examples 2 to 5

Under the polymerization condition shown in Table 1, the molecular weight was controlled by changing the polymerization temperature and the polymerization pressure to produce a highly-pure, terminal-unsaturated polypropylene. The polymer was evaluated according to the above-mentioned methods, and the results are shown in Table 2.

### Examples 6 and 7

In the presence of minor hydrogen, a highly-pure, terminal-unsaturated polypropylene was produced under the condition shown in Table 1, and evaluated according to the above-mentioned methods. The results are shown in Table 2. The polymerization process was the same as in Example 1, but in this, hydrogen was introduced into the system as follows: After the transition metal catalyst ingredient was introduced into the system, a predetermined amount of hydrogen previously collected at room temperature under ordinary pressure was introduced thereinto with a syringe, while the autoclave was kept airtight as such.

### Example 8

A highly-pure, terminal-unsaturated polypropylene was produced in the same manner as in Example 1, for which, however, propylene was changed to 200 ml of 1-butene, and the amount of tributylaluminium to be used, the amount of the transition metal compound to be used, and the polymerization temperature and time were changed as in Table 1. In this, 1-butene was put into the autoclave from a pressure glass container. Thus obtained, the highly-pure terminal-unsaturated polypropylene was evaluated according to the above-mentioned methods. The results are shown in Table 2. {[mmmm]/[mmrr]+[rmmr]} was 9.0.

### Comparative Examples 1 and 2

Polypropylene was produced in the same manner as in Examples 6 and 7 under the condition shown in Table 1 but in the presence of a large quantity of hydrogen, and evaluated according to the above-mentioned methods. The results are shown in Table 2.

TABLE 1

| | | | | Transition | | | | | | |
|---|---|---|---|---|---|---|---|---|---|---|
| | | | | Metal | | | | | | |
| | C7 | TiBA | [B] | Compound | (H₂/TM) | Propylene | 1-Butene | Temperature | Time | Yield |
| | (ml) | (mmol) | (μmol) | (μmol) | (mol/mol) | (MPa) | (ml) | (° C.) | (min) | (g) |
| Example 1 | 400 | 0.5 | 1.5 | 0.5 | 0 | 0.8 | — | 70 | 120 | 123 |
| Example 2 | 400 | 0.5 | 1.5 | 0.5 | 0 | 0.3 | — | 70 | 120 | 55.3 |
| Example 3 | 400 | 0.5 | 1.5 | 0.5 | 0 | 0.8 | — | 80 | 120 | 81.5 |
| Example 4 | 400 | 0.5 | 1.5 | 0.5 | 0 | 0.8 | — | 55 | 120 | 52.0 |
| Example 5 | 400 | 0.5 | 1.5 | 0.5 | 0 | 0.8 | — | 90 | 120 | 52.2 |
| Example 6 | 400 | 0.5 | 1.5 | 0.5 | 100 | 0.5 | — | 70 | 120 | 143 |
| Example 7 | 400 | 0.5 | 1.5 | 0.5 | 1000 | 0.5 | — | 70 | 80 | 131 |
| Example 8 | 400 | 0.5 | 3.2 | 1.6 | 700 | — | 200 | 90 | 60 | 89.0 |
| Comparative | 400 | 0.5 | 1.5 | 0.5 | 40000 | 0.8 | — | 70 | 80 | 140 |
| Example 1 | | | | | | | | | | |
| Comparative | 400 | 0.5 | 1.5 | 0.5 | 80000 | 0.8 | — | 70 | 80 | 142 |
| Example 2 | | | | | | | | | | |

C7: Dry heptane
TiBA: Triisobutylaluminium
[B]: Methylanilinium tetrakis(perfluorophenyl)borate
Transition metal compound: (1,2′-dimethylsilylene)(2,1′-dimethylsilylene)-bis(3-trimethylsilylmethylindenyl)zirconium dichloride
TM: Transition metal compound

TABLE 2

| | | Molecular | Terminal | | | | | | |
|---|---|---|---|---|---|---|---|---|---|
| | | Weight | Vinylidene | | | | Transi- | | |
| | Intrinsic | Distri- | Group | | | | tion | | |
| | Viscosity | bution | Content | [mmmm] | [rmrm] | Tm | Metal | Aluminium | Boron |
| | (dl/g) | Mw/Mn | (/molecule) | (mol %) | (mol %) | (° C.) | (ppm) | (ppm) | (ppm) |
| Example 1 | 0.85 | 2.08 | 0.98 | 43.6 | 3.0 | 71.0 | 1> | 110 | 1> |
| Example 2 | 0.57 | 2.23 | 0.97 | 41.9 | 3.3 | 68.3 | 1> | 240 | 1> |
| Example 3 | 0.48 | 1.98 | 0.98 | 40.5 | 2.9 | 65.8 | 1> | 160 | 1> |
| Example 4 | 1.79 | 2.00 | 0.98 | 46.2 | 3.0 | 75.6 | 1> | 260 | 1> |
| Example 5 | 0.32 | 1.90 | 0.99 | 37.5 | 3.1 | 60.0 | 1> | 250 | 1> |
| Example 6 | 0.61 | 1.88 | 0.89 | 42.6 | 3.0 | 69.7 | 1> | 90 | 1> |
| Example 7 | 0.60 | 1.75 | 0.88 | 42.5 | 3.0 | 69.0 | 1> | 100 | 1> |
| Example 8 | 0.16 | 2.18 | 0.70 | 61.6 | — | 56.1 | 3 | 140 | 2 |
| Comparative | 0.26 | 1.89 | 0.04 | 43.7 | 3.0 | 70.8 | 1> | 90 | 1> |
| Example 1 | | | | | | | | | |
| Comparative | 0.20 | 1.80 | 0.04 | 43.7 | 3.1 | 71.0 | 1> | 90 | 1> |
| Example 2 | | | | | | | | | |

The terminal vinylidene group content was determined through GPC and 1H-NMR.

In Examples 1 to 7, the transition metal and boron were below the detection limit; but in computation on the presumption that all the catalyst ingredients were taken in the polymer, the transition metal (zirconium) was from 0.32 to 0.88 ppm by mass, and the boron was from 0.11 to 0.32 ppm by mass.

### Examples 9 to 13

Dry heptane (0.4 L), triisobutylaluminium (0.5 mmol)/heptane solution (1 ml), and methylanilinium tetrakis(perfluorophenyl)borate (4 μmol)/heptane slurry (4 ml) were put in a stainless steel-made autoclave having an inner capacity of 1.4 L and dried by heating, and stirred for 10 minutes. A heptane slurry (2 ml) of (1,2′-dimethylsilylene) (2,1′-dimethylsilylene)-bis(3-trimethylsilylmethylindenyl)zirconium dichloride (1.5 μmol) prepared in Example 1-(1) was put into it.

Next, at room temperature, a predetermined amount of hydrogen was introduced into it, and the temperature was elevated up to 80° C. with stirring, and propylene gas was introduced to be a propylene partial pressure of 0.5 MPa. During the polymerization reaction, propylene gas was kept introduced via a pressure controller so that the pressure could be kept constant, to attain the polymerization for 40 minutes, and then this was cooled, the unreacted propylene was removed by depressurizing, and the contents were taken out. The contents were processed in the same manner as in Example 1-(2) to give polypropylene. The test data of the thus-obtained polypropylene are shown in Table 3.

### Example 14

### (1) Synthesis of Metal Complex

In the manner mentioned below, (1,2′-dimethylsilylene) (2,1′-dimethylsilylene)-(indenyl) (3-trimethylsilylmethylindenyl)zirconium dichloride was synthesized.

In a nitrogen current, ether (50 ml) and (1,2′-dimethylsilylene) (2,1′-dimethylsilylene)-bisindene (3.5 g, 1.02 mmol) were put into a 200 ml-volume Schlenk bottle, and at −78° C., n-butyllithium (n-BuLi)/hexane solution (1.60 mol/L, 12.8 mmol) was dropwise added thereto. This was stirred at room temperature for 8 hours, then the solvent was evaporated away, and the resulting solid was dried under reduced pressure to give a white solid (5.0 g). The solid was dissolved in tetrahydrofuran (THF) (50 ml), and iodomethyltrimethylsilane (1.4 ml) was dropwise added thereto at room temperature. This was hydrolyzed with water (10 ml), then the organic phase was extracted with ether (50 ml). The organic phase was dried to remove the solvent through evaporation. Ether (50 ml) was added to it, and at −78° C., n-BuLi/hexane solution (1.60 mol/L, 12.4 ml) was dropwise added thereto. Then, this was heated up to room temperature and stirred for 3 hours, and ether was evaporated away. The resulting solid was washed with hexane (30 ml), and then dried under reduced pressure. The white solid (5.11 g) was suspended in toluene (50 ml), and zirconium tetrachloride (2.0 g, 8.60 mmol) suspended in toluene (10 ml) in a different Schlenk bottle was added to it. This was stirred at room temperature for 12 hours, then the solvent was evaporated away, and the residue was washed with hexane (50 ml). The residue was recrystallized from dichloromethane (30 ml) to give a yellow fine crystal (1.2 g, yield 25%).

### (2) Polymerization of Propylene:

Dry heptane (2.5 L), triisobutylaluminium (1.4 mmol)/heptane solution (1.4 ml), and methylanilinium tetrakis(perfluorophenyl)borate (15.4 μmol)/heptane slurry (2 ml) were put in a stainless steel-made autoclave having an inner capacity of 5 L and dried by heating, and stirred for 10 minutes while controlled at 50° C.

Further, a heptane slurry (6 ml) of the transition metal compound complex prepared in the above (1), (1,2′-dimethylsilylene)(2,1′-dimethylsilylene)-(indenyl) (3-trimethylsilylmethylindenyl)zirconium dichloride (3.8 μmol) was put into it.

Further, hydrogen was introduced into it, and the temperature was elevated up to 60° C. with stirring, and propylene gas was introduced up to a partial pressure of 0.49 MPa.

During the polymerization reaction, propylene gas was kept introduced via a pressure controller so that the pressure could be kept constant, to attain the polymerization for 100 minutes, and then this was cooled, the unreacted propylene was removed by degassing, and the contents were taken out.

The contents were dried in air, further dried under reduced pressure at 80° C. for 8 hours to give reactive polypropylene (525 g). The results are shown in Table 3.

### Example 15

Polypropylene was produced in the same manner as in Example 9, for which, however, H₂/Zr was changed to 40. The results are shown in Table 3.

TABLE 3

| | | | | Molecular | Terminal | Proportion of | | | | | | |
|---|---|---|---|---|---|---|---|---|---|---|---|---|
| | | | | Weight | Vinylidene | Terminal Vinyl | | | | Transi- | | |
| | | | Intrinsic | Distri- | Group | Group to | | | | tion | | |
| | (H₂/TM) | Yield | Viscosity | bution | Content | Unsaturated | [mmmm] | [rmrm] | Tm | Metal | Aluminium | Boron |
| | (mol/mol) | (g) | (dl/g) | Mw/Mn | (/molecule) | Group (%) | (mol %) | (mol %) | (° C.) | (ppm) | (ppm) | (ppm) |
| Example 9 | 0 | 48.1 | 0.362 | 2.47 | 0.84 | 14.5 | 40.3 | 2.9 | 65.9 | 3 | 270 | 1> |
| Example 10 | 600 | 122.5 | 0.361 | 2.13 | 0.89 | 11.3 | 40.1 | 3.0 | 65.7 | 1 | 110 | 1> |
| Example 11 | 1500 | 130.0 | 0.364 | 1.83 | 0.92 | 6.6 | 40.2 | 3.0 | 65.5 | 1> | 100 | 1> |
| Example 12 | 3000 | 189.5 | 0.367 | 1.75 | 0.99 | 3.77 | 40.3 | 3.0 | 66.0 | 1> | 66 | 1> |
| Example 13 | 6000 | 199.6 | 0.350 | 1.73 | 0.93 | 2.95 | 40.5 | 2.9 | 65.7 | 1> | 64 | 1> |
| Example 14 | 58.7 | 525 | 0.400 | 1.84 | 0.96 | 5.10 | 55.2 | — | 98.2 | 1> | 70 | 1> |
| Example 15 | 40 | 60.5 | 0.367 | 2.36 | 0.88 | 13.4 | 40.2 | 2.9 | 65.7 | 2 | 210 | 1> |

The terminal vinylidene group content was determined through GPC and 1H-NMR.

### INDUSTRIAL APPLICABILITY

The highly-pure, terminal-unsaturated olefin polymer of the present invention is favorable as a reactive precursor for efficiently producing modified polymers.

1. A highly-pure, terminal-unsaturated olefin polymer produced by homopolymerization or copolymerization of one or more α-olefins having from 3 to 28 carbon atoms, or copolymerization of at least one α-olefin having from 3 to 28 carbon atoms and ethylene, in the presence of a catalyst, wherein:
(1) A content of a transition metal derived from the catalyst is at most 10 ppm by mass, a content of aluminium is at most 300 ppm by mass, and a content of boron is at most 10 ppm by mass;
(2) The polymer has from 0.5 to 1.0 vinylidene group/molecule as the terminal unsaturated group;
(3) The polymer has an intrinsic viscosity (η), as measured in decalin at 135° C., of from 0.01 to 2.5 dl/g; and
(4) The polymer has a molecular weight distribution (Mw/Mn) of at most 4.

2. The highly-pure, terminal-unsaturated olefin polymer according to claim 1, wherein the polymer has from 0.8 to 1.0 vinylidene group/molecule as the terminal unsaturated group.

3. The highly-pure, terminal-unsaturated olefin polymer according to claim 1, wherein the olefin polymer is a propylene homopolymer, or a copolymer of at least 90% by mass of propylene and at most 10% by mass of at least one selected from the group consisting of ethylene and α-olefins having from 4 to 28 carbon atoms, and has a mesopentad fraction (mmmm) of from 30 to 80 mol %.

4. The highly-pure, terminal-unsaturated olefin polymer according to claim 3, wherein:
(a) (rmrm)>2.5 mol %, and
(b) 1.76(mmmm)−25.0≦Tm≦1.76(mmmm)+5.0
wherein Tm is the melting point (° C.) of the polymer as measured with a differential scanning calorimeter (DSC) and (mmmm) is the mesopentad fraction.

5. The highly-pure, terminal-unsaturated olefin polymer according to claim 1, wherein the olefin polymer is a 1-butene homopolymer, or a copolymer of at least 90% by mass of 1-butene and at most 10% by mass of at least one selected from ethylene, propylene and α-olefins having from 5 to 28 carbon atoms, and has a mesopentad fraction (mmmm) of from 20 to 90 mol %.

6. The highly-pure, terminal-unsaturated polyolefin polymer according to claim 5, wherein:
(p) The polymer is a resin not having a melting point (Tm) in differential scanning calorimetry (DSC) or a crystalline resin having a melting point (Tm) of from 0 to 100° C.; and
(q) {(mmmm)/(mmrr)+(rmmr)}≦20.

7. A method for producing a highly-pure, terminal-unsaturated olefin polymer according to claim 1, comprising carrying out homopolymerization or copolymerization of one or more α-olefins having from 3 to 28 carbon atoms, or copolymerization of at least one α-olefin having from 3 to 28 carbon atoms with ethylene, in the presence of a catalyst comprising following (A) and (B), or following (A), (B) and (C), wherein the polymerization reaction is attained in a molar ratio of hydrogen to the transition metal compound (hydrogen/transition metal compound) of from 0 to 10000:
(A) A transition metal compound having a cyclopentadienyl group, a substituted cyclopentadienyl group, an indenyl group or a substituted indenyl group and comprising a metal element of Groups 3 to 10 of the Periodic Table;
(B) A compound which reacts with the transition metal compound to form an ionic complex;
(C) An organoaluminium compound.

8. The method for producing a highly-pure, terminal-unsaturated olefin polymer according to claim 7, wherein the polymerization reaction is attained in a molar ratio of hydrogen to the transition metal compound (hydrogen/transition metal compound) of from 0 to 5000.

9. The method for producing a highly-pure, terminal-unsaturated olefin polymer according to claim 7, wherein the transition metal compound is a double-crosslinked complex of a general formula (I): 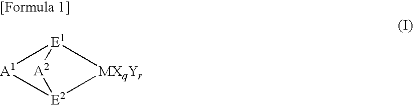
wherein M represents a metal element of Groups 3 to 10 of the Periodic Table; E¹ and E² each represent a ligand selected from the group consisting of a cyclopentadienyl group, a substituted cyclopentadienyl group, an indenyl group, a substituted indenyl group, a heterocyclopentadienyl group, a substituted heterocyclopentadienyl group, an amide group, a phosphine group, a hydrocarbon group and a silicon-containing group, and form a crosslinking structure via A¹ and A²; E¹ and E² may be the same or different, and at least one of E¹ and E² is a cyclopentadienyl group, a substituted cyclopentadienyl group, an indenyl group or a substituted indenyl group; X represents a σ-bonding ligand; plural X's, if any, may be the same or different, and may crosslink with the other X, E¹, E² or Y; Y represents a Lewis base; plural Y's, if any, may be the same or different, and may crosslink with the other Y, E¹, E² or X; A¹ and A² each are a divalent crosslinking group that bonds two ligands, representing a hydrocarbon group having from 1 to 20 carbon atoms, a halogen-containing hydrocarbon group having from 1 to 20 carbon atoms, a silicon-containing group, a germanium-containing group, a tin-containing group, —O—, —CO—, —S—, —SO₂—, —Se—, —NR¹—, —PR¹—, —P(O)R¹—, —BR¹— or —AlR¹— where R¹ represents a hydrogen atom, a halogen atom, a hydrocarbon group having from 1 to 20 carbon atoms, or a halogen-containing hydrocarbon group having from 1 to 20 carbon atoms, and A¹ and A² may be the same or different; q indicates an integer of from 1 to 5, and is ((atomic valence of M)−2); r indicates an integer of from 0 to 3.
